(19) United States
(12) Patent Application Publication
(10) Pub. No.: US 2012/0062425 A1
(43) Pub. Date: Mar. 15, 2012

(54) PHASED ARRAY ANTENNA SYSTEM WITH INTERMODULATION BEAM NULLING

(76) Inventors: James P. McKay, Hermosa Beach, CA (US); David A. Ksienski, Los Angeles, CA (US)

(21) Appl. No.: 12/879,962

(22) Filed: Sep. 10, 2010

(51) Int. Cl. H01Q 3/00

(52) U.S. Cl. 342/377

(57) ABSTRACT

A phased array antenna system with intermodulation beam nulling device includes nulling phase shifters.

### GOVERNMENT INTEREST

This invention was made with government support under Contract No. FA8802-04-C-0001 awarded by the Department of the Air Force. The government has certain rights in the invention.

### BACKGROUND OF THE INVENTION

1. Field of the Invention

The present invention relates to improving transmitted signal quality in an active phased array antenna utilizing solid state power amplifiers transmitting two or more fundamental communications beams. In particular, selected intermodulation beams arising from nonlinear amplifier operation are nulled to improve signal quality.

2. Discussion of the Related Art

Active phased array antennas include a plurality of radiators driven by respective amplifiers. FIG. 1 shows a prior art active phased antenna 100. The antenna has radiators 120 located at the intersections of lines of a corresponding x-y rectangular grid. Radiators may be located in the grid by reference to an (x,y) coordinate such as (1,1) or (3,3). This two coordinate referencing system is used in some antenna equations. Another coordinate referencing system uses one coordinate, each element being sequentially numbered. For example, in a 3×3 array, element (1,1) becomes element 1 and element 3,3 becomes element 9. This referencing system is used in some antenna equations.

FIG. 2A shows a prior art active phased array antenna 200A. A beam forming section incorporating “i” beam forming elements 250 is coupled with signal(s) 224 and commanded angle inputs 222. Signal(s) with an applied phase shift for beam steering 255 are outputs of the beam forming section and are coupled to the feed chain section incorporating “i” feed chain elements 254. Feed chain section outputs 257 are coupled to “i” radiators 220 of an antenna array 260.

FIG. 2B shows a more detailed version 200B of the prior art active phased array of FIG. 2A. Here, an i^{th} radiator 220 is coupled with incoming signals S₁, S₂ via an i^{th} antenna beam forming element 204 of beam forming section 250 and an i^{th} feed chain element 205 of feed chain section 254. In this embodiment, a fundamental beam steering processor 202 is common to a plurality of antenna beam forming sections.

As used herein, the term processor refers to a device for processing information. In particular, digital processors such as microprocessors and other digital processing devices are included. Various processor embodiments include one or more processors. And, some processor embodiments include one or more memory device(s) such as semiconductor and/or hard disc drive memory devices and input/output device(s) such as bus communications, parallel communications, and serial communications devices.

Beam forming section inputs include a plurality of signals 224 and their related angles 222. For each signal S₁, S_{2,} two angles, commanded elevation θ₀ and azimuth φ₀ determine the direction of the beam carrying the signal and therefore the intended receiver of the signal. For example, a first fundamental beam might be directed to a receiver in a first city at the angle pair (θ₀, φ₀) and a second fundamental beam might be directed to another receiver in another city at the angle pair (θ′₀, φ′₀). Manipulating the direction of a communication beam is sometimes referred to as steering the beam.

Beam forming entails creation of a phase front for each beam that is normal to the desired direction of the beam. These phase fronts are created by appropriately shifting the phases of the incoming signals S₁, S₂ in beam forming elements 204. Each one of “i” antenna beam forming elements includes steering phase shifters PSᵢ₁, PSᵢ₂ that create corresponding shifted signals Sᵢ₁ₐ, Sᵢ₂ₐ. In various embodiments, the phase shifters include one or both of digital and analog phase shifters.

Phase shifts Zᵢ₁, Zᵢ₂ are applied to the signals S₁, S₂ to create shifted signals Sᵢ₁ₐ, Sᵢ₂ₐ. In an embodiment, the phase shifts are calculated within the fundamental beam steering processor 202. And, in an embodiment, these applied phase shifts are functions of uniform progressive phases αₓ, α_{y} as shown in equations 1a,b below.

Zᵢ₁=q₁(α_{1,x}, α_{1,y}) Equation 1a

Zᵢ₂=q₂(α′_{1,x},α′_{1,y}) Equation 1b

As shown in equations 2a-d below, the uniform progressive phases αₓx, α_{y} are determined by the commanded beam angle pairs θ₀, φ₀ and θ′₀, φ′₀.

$$\begin{matrix}tan {φ}_{0} = \frac{{α}_{1 , y}}{{α}_{1 , x}} & Equation 2 a \\ {sin}^{2} {θ}_{0} = \frac{{α}_{1 , x}^{2} + {α}_{1 , y}^{2}}{{( 2 π d / λ )}^{2}} & Equation 2 b \\ tan {φ}_{0}^{′} = \frac{{α}_{1 , y}^{′}}{{α}_{1 , x}^{′}} & Equation 2 c \\ {sin}^{2} {θ}_{0}^{′} = \frac{{α}_{1 , x}^{′2} + {α}_{1 , y}^{′2}}{{( 2 π d / λ )}^{2}} & Equation 2 d\end{matrix}$$

Note, equations 2a-d assume dₓ=d_{y}=d. This assumption simplifies the analysis and the equations.

Phase shifter outputs Sᵢ₁ₐ and Sᵢ₂ₐ are combined and amplified in the i^{th} feed chain element 205 that includes a signal combiner 210 and a solid state amplifier 212. The signal combiner 210 is coupled to the input signals Sᵢ₁ₐ, Sᵢ₂ₐ and its output 211 is amplified in the amplifier. The i^{th} radiator element 220 is coupled to the amplifier 212 via an amplifier output 213.

### SUMMARY OF THE INVENTION

A phased array antenna system includes phase shifters for nulling selected intermodulation beams. In an embodiment, a nulling section is interposed between a beam forming section and a feed chain section and an antenna has a plurality of radiators, each radiator being coupled to a respective amplifier in the feed chain section. Each amplifier is coupled to a respective nulling phase shifter in the nulling section and each nulling phase shifter is coupled to a respective steering phase shifter in the beam forming section. One or more processors are for activating the phase shifters. The phased array antenna system is operative to simultaneously transmit a plurality of signals to respective locations.

In an embodiment, the phased array antenna system includes one or more processors for calculating directivity patterns and one or more memory devices for storing calculated directivity patterns. A signal sampler is for sampling fundamental and intermodulation forward and reflected traveling wave signal levels at the input of each radiator and one or more processors are for updating the stored directivity patterns in accordance with the sample values.

In an embodiment a single processor is used. And, in an embodiment, the beam forming section includes a processor and the nulling section includes a processor.

### BRIEF DESCRIPTION OF THE DRAWINGS

The present invention is described with reference to the accompanying figures. These figures, incorporated herein and forming part of the specification, illustrate embodiments of the invention and, together with the description, further serve to explain its principles enabling a person skilled in the relevant art to make and use the invention.

FIG. 1 shows a schematic diagram of a prior art rectangular antenna array.

FIG. 2A shows a block diagram of a prior art phased array antenna.

FIG. 2B shows a more detailed version of the block diagram of FIG. 2A.

FIG. 3A shows a block diagram of a phased array antenna in accordance with the present invention.

FIG. 3B shows a more detailed version of the block diagram of FIG. 3A.

FIGS. 4A-B show selected nulling phase distributions for use with the antenna of FIG. 3A.

FIG. 5 shows an enhanced version of the block diagram of FIG. 3A.

FIGS. 6A-C show a method of operation of a phased array antenna such as the antenna of FIG. 3A.

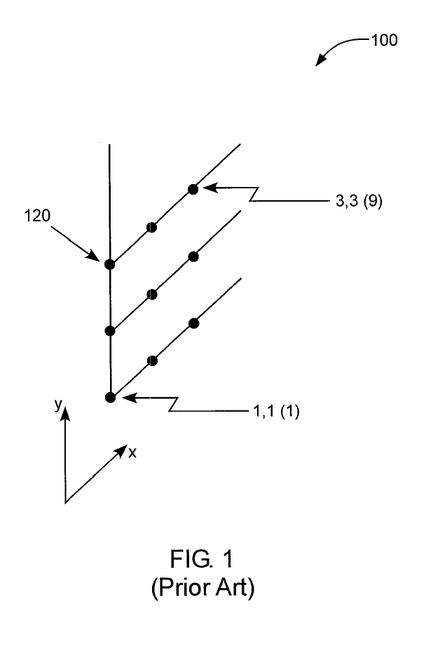

### DETAILED DESCRIPTION OF THE PREFERRED EMBODIMENTS

The disclosure provided in the following pages describes examples of some embodiments of the invention. The designs, figures, and descriptions are non-limiting examples of the embodiments they disclose. For example, other embodiments of the disclosed device and/or method may or may not include the features described herein. Moreover, disclosed advantages and benefits may apply only to certain embodiments of the invention and should not be used to limit the disclosed invention.

As used herein, the term “coupled” includes direct and indirect connections. Moreover, where first and second devices are coupled, other devices including active devices may be interposed between them.

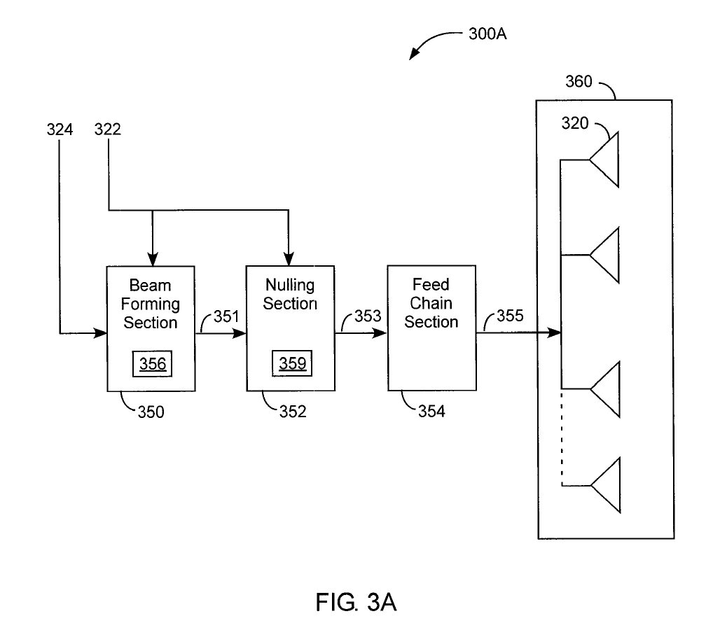

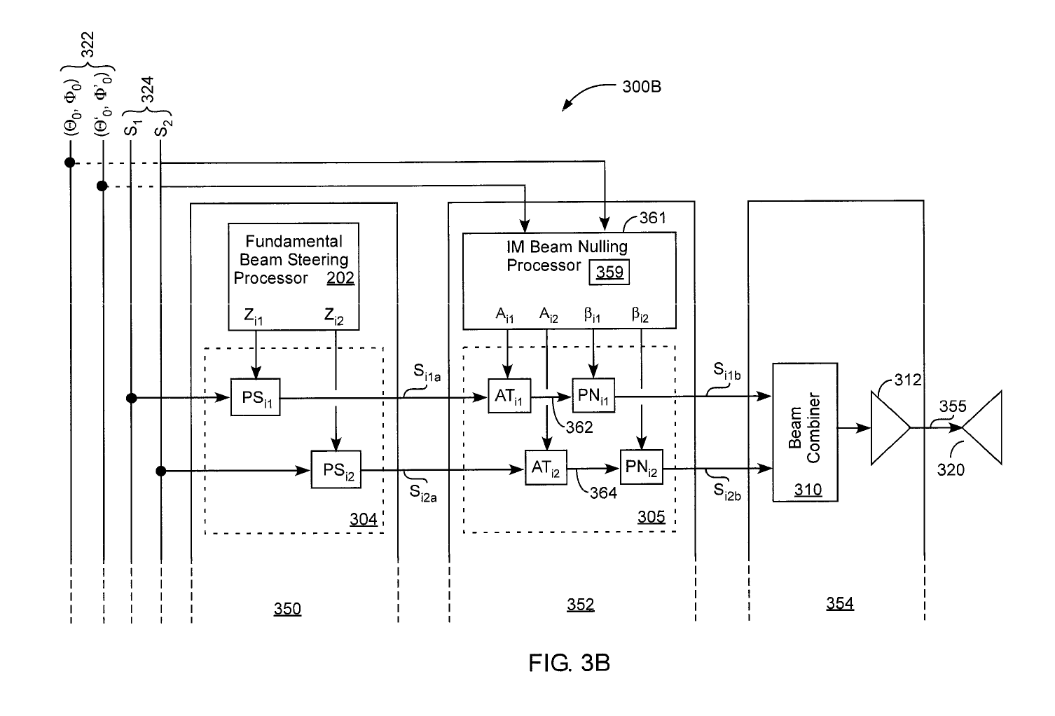

FIG. 3A shows an active array antenna system including a nulling device in accordance with the present invention 300A. A beam forming section incorporating “i” beam forming elements 350 is coupled with signals 324 and commanded angle inputs 322. As persons of ordinary skill in the art will understand, the present invention is applicable where two or more signals are involved. The examples herein utilize two signals to illustrate the invention and not by way of limitation.

A nulling section incorporating “i” nulling elements 352 is coupled with commanded angle inputs 322. Signals with an applied phase shift for beam steering are outputs 351 of the beam forming section and are coupled to the nulling section 352. Nulling section outputs 353 are coupled with a feed chain section incorporating “i” feed chain elements 354. The feed chain section is coupled 355 with “i” radiators 320 of an antenna array 360.

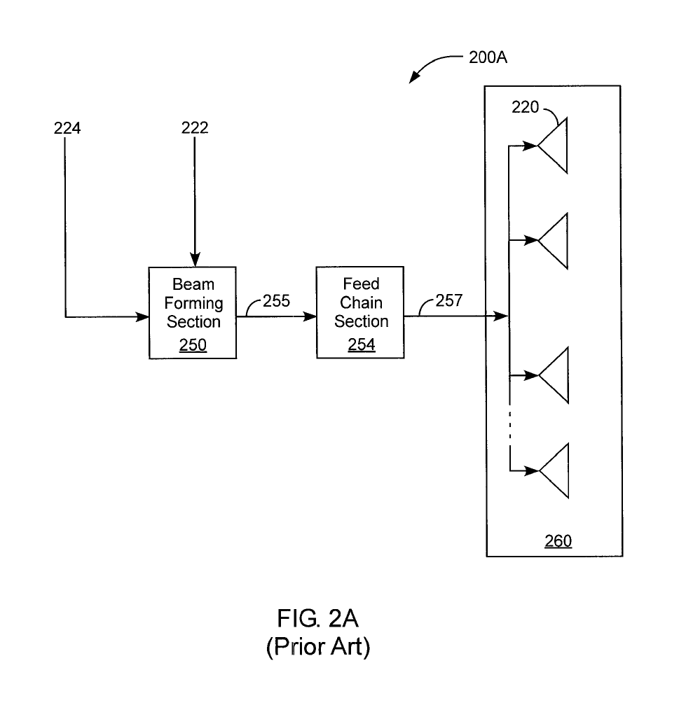

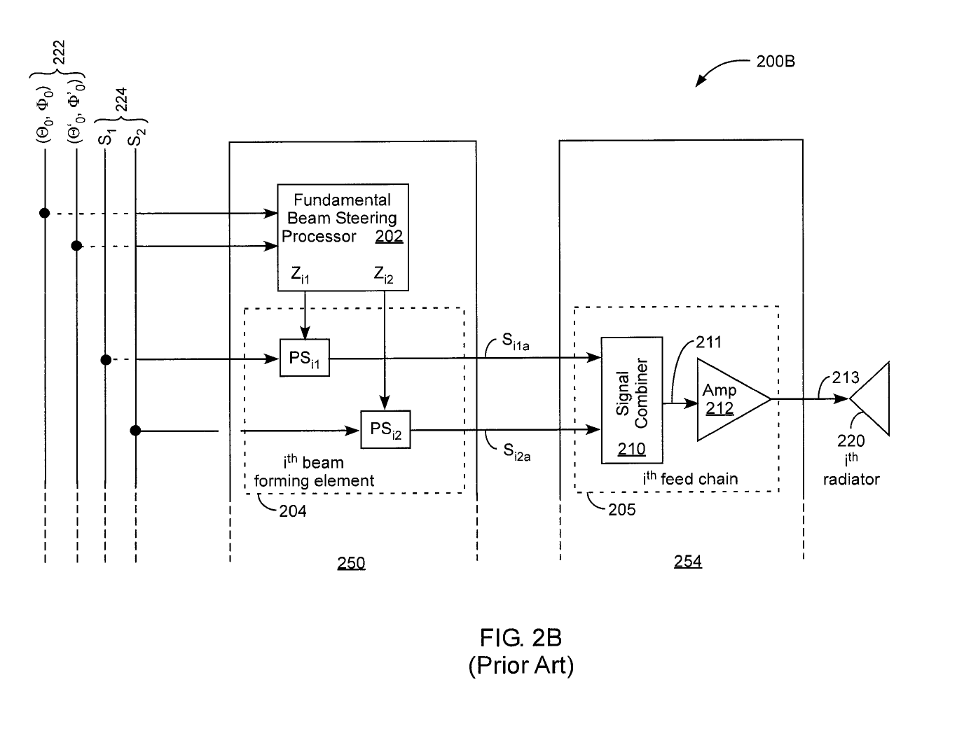

A comparison of FIGS. 2A and 3A shows that present invention improves over the prior art by adding a nulling section to an active phased array antenna system 300A.

FIG. 3B shows a more detailed version 300B of the nulling device of FIG. 3A. A beam forming section 350 includes an i^{th} beam forming element 304 and a feed chain section 354 includes an i^{th} beam combiner 310 and an i^{th} amplifier 312. As can be seen, these beam forming and feed chain sections 350, 354 are similar to those discussed above in connection with FIGS. 2A-B. However, unlike the prior art, the steering phase shifter outputs Sᵢ₁ₐ, Sᵢ₂ₐ are processed a second time in a nulling section 352 that has “i” nulling elements 305 and is located between the beam forming and feed chain sections. As persons of ordinary skill in the art will understand, the nulling section might be located differently with respect to components of the beam forming and feed chain sections.

During operation of the invention's nulling function, attenuators ATᵢ₁, ATᵢ₂ are used to equalize radiator amplitudes by applying suitable attenuations A₁₁, A₁₂, A₂₁, A₂₂ . . . A_{M1}, A_{M2} (where M represents the number of elements in the array) and nulling phase shifters PNᵢ₁, PNᵢ₂ are used to apply a nulling phase distribution. In various embodiments, the phase shifters include one or both of digital and analog phase shifters. Because it is not always beneficial to operate this nulling functionality, embodiments of the invention adapt by selectively operating the nulling function.

When the nulling function is not in operation, a) attenuators ATᵢ₁, ATᵢ₂ apply a uniform attenuation to signals such that A₁₁=A₂₁= . . . A_{M1}=A₁₂=A₂₂= . . . =A_{M2}=0 and b) nulling phase shifters PNᵢ₁, PNᵢ₂ apply a uniform phase distribution to signals such that β₁₁=β₂₁= . . . =β_{M1}=β₁₂=β₂₂= . . . =β_{M2}=0. Adaptive functionality is discussed further below, after operation of the nulling phase shifters has been described.

In the nulling section 352, the once shifted signals Sᵢ₁ₐ, Sᵢ₂ₐ are attenuated by respective attenuators ATᵢ₁, ATᵢ₂ to equalize their levels. Nulling phase shifters PNᵢ₁, PNᵢ₂ are provided to process the attenuated signals 362, 364 creating twice shifted signals S_{i1b}, S_{i2b}. One or more processors perform these functions. In an embodiment, an intermodulation beam nulling processor 361 is coupled to the commanded angle signals 322 and provides a) attenuating outputs Aᵢ₁, Aᵢ₂ coupled to respective attenuators ATᵢ₁, ATᵢ₂ and b) phase shifting outputs βᵢ₁, βᵢ₂ coupled to respective phase shifters PNᵢ₁, PNᵢ₂.

Nulling unwanted intermodulation beams (“IM” beam or “IMB”) entails applying a nulling phase distribution to signals passing through the nulling section 352. The nulling phase distribution shifts the phases of all of the signals Sᵢ₁ₐ, Sᵢ₂ₐ by a nulling angle β_{u,i} with a magnitude of 90/N degrees where N is the order of the intermodulation beam to be nulled. See the appendix to this specification for further explanation of these nulling phase shifts.

Referring to β_{u,i} as the nulling phase change for the u^{th} signal and the ith array element, in an exemplary 3×3 phased array antenna, the nulling phase distribution (in degrees) for the first signal is below.

| | | | | | |
|---|---|---|---|---|---|
| β_{1,7} | −90/N | β_{1,8} | 90/N | β_{1,9} | −90/N |
| β_{1,4} | 90/N | β_{1,5} | −90/N | β_{1,6} | 90/N |
| β_{1,1} | −90/N | β_{1,2} | 90/N | β_{1,3} | −90/N |

Similarly, the nulling phase distribution for the second signal is below.

| | | | | | |
|---|---|---|---|---|---|
| β_{2,7} | 90/N | β_{2,8} | −90/N | β_{2,9} | 90/N |
| β_{2,4} | −90/N | β_{2,5} | 90/N | β_{2,6} | −90/N |
| β_{2,1} | 90/N | β_{2,2} | −90/N | β_{2,3} | 90/N |

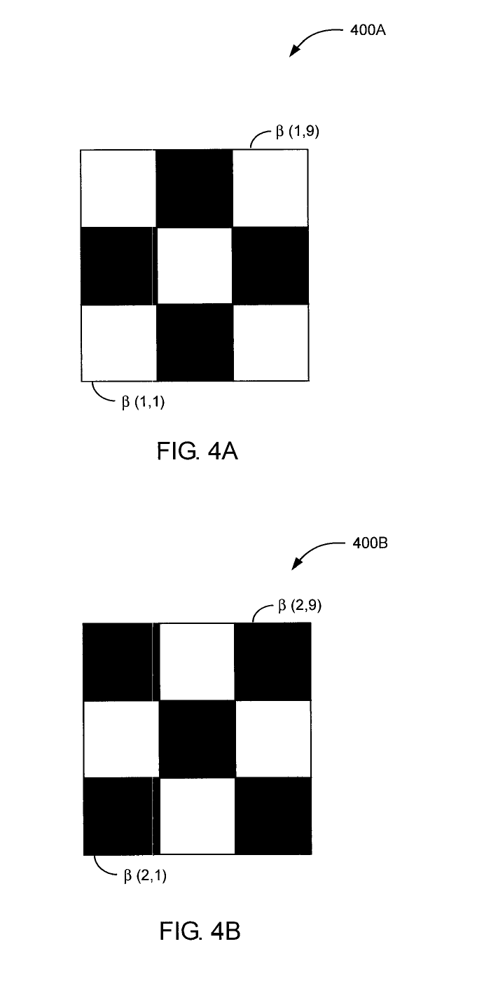

These nulling phase distributions have a “checkerboard” type pattern where each successive element has a phase shift of equal magnitude but of opposite sign. FIGS. 4A and 4B show graphic representations 400A, 400B of these checkerboard nulling phase distributions for signals 1 and 2.

In some embodiments, a single set of phase shifters applies both the steering and the nulling phase shifts. In these embodiments, the steering phase shifts Zᵢ₁, Zᵢ₂ are added to the respective nulling phase shifts βᵢ₁, βᵢ₂ and the combined shifts are applied to respective phase shifters. For example, the phase shifts can be combined in a single processor carrying out the functions of the fundamental beam steering processor 202 and the intermodulation beam nulling processor 359.

Turning now to the question of whether nulling phase distributions should be applied, a means for comparing the attenuation of fundamental beams (undesirable) and the attenuation of intermodulation beams (desirable) is required. For example, if application of the nulling phase distribution increases the directivity of selected intermodulation beam(s) while the corresponding fundamental beam is little changed, the application is detrimental.

As shown in Section 2.0 of the appendix, the directivity D of a beam depends on the complex (amplitude and phase) excitation of the mn^{th} element designated Iₘₙ, elevation and azimuth angles (θ, φ), and the spacing between rows dₓ and columns d_{y} of the phased array. In particular, the peak directivity of the fundamental beams can be expressed as functions of these variables.

D_{1st fundamental beam}=D1F=D(Iₘₙ,θ₀,φ₀,dₓ,d_{y}) Equation 3a

D_{2nd fundamental beam}=D2F =D(I′ₘₙ,θ′₀,φ′₀,dₓ,d_{y}) Equation 3b

The peak directivity of the intermodulation beams of a selected order N also depends on these variables. In particular, the values of progressive phases (α_{N,x}, α_{N,y}, α′_{N,x}, α′_{N,y}) corresponding to an N^{th} order intermodulation beam are calculated as indicated below.

$$\begin{matrix}{α}_{N , x} = \frac{N + 1}{2} {α}_{1 , x} - \frac{N - 1}{2} {α}_{1 , x}^{′} & Equation 4 a \\ {α}_{N , y} = \frac{N + 1}{2} {α}_{1 , y} - \frac{N - 1}{2} {α}_{1 , y}^{′} & Equation 4 b \\ {α}_{N , x}^{′} = \frac{N + 1}{2} {α}_{1 , x}^{′} - \frac{N - 1}{2} {α}_{1 , x} & Equation 4 c \\ {α}_{N , y}^{′} = \frac{N + 1}{2} {α}_{1 , y}^{′} - \frac{N - 1}{2} {α}_{1 , y} & Equation 4 d\end{matrix}$$

To obtain the related intermodulation beam elevation and azimuth scan angles (θ_{N,0}, φ_{N,0}, θ′_{N,0}, φ′_{N,0}), the progressive phase values of equations 4a-d are used in Equations 5a-c (similar to Equations 2a-c) to solve for these values.

$$\begin{matrix}tan {φ}_{N , 0} = \frac{{α}_{N , y}}{{α}_{N , x}} & Equation 5 a \\ {sin}^{2} {θ}_{N , 0} = \frac{{α}_{N , x}^{2} + {α}_{N , y}^{2}}{{( 2 π d / λ )}^{2}} & Equation 5 b \\ tan {φ}_{N , 0}^{′} = \frac{{α}_{N , y}^{′}}{{α}_{N , x}^{′}} & Equation 5 c \\ {sin}^{2} {θ}_{N , 0}^{′} = \frac{{α}_{N , x}^{′2} + {α}_{N , y}^{′2}}{{( 2 π d / λ )}^{2}} & Equation 5 d\end{matrix}$$

Note, equations 5a-d assume dₓ=d_{y}=d. This assumption simplifies the analysis and the equations.

Peak directivity of the intermodulation beams is calculated using the directivity equation discussed above.

D_{1st intermodulation beam}=D1I=D(Iₘₙ,θ_{N},φ_{N},dₓ,d_{y}) Equation 6a

D_{2nd intermodulation beam}=D2I=D(I′ₘₙ,θ_{N′},φ_{N′},dₓ,d_{y}) Equation 6b

Directivities before and after application of the nulling phase distribution can now be calculated and compared.

| | Directivity Before | Directivity After |
|---|---|---|
| | Application | Application |
| | Of Nulling | Of Nulling |
| | Distribution | Distribution |
| 1^{st} Fundamental Beam | D1FB | D1FA |
| 2^{nd} Fundamental Beam | D2FB | D2FA |
| 1^{st} Intermodulation | D1IB | D1IA |
| Beam | | |
| 2^{nd} Intermodulation | D2IB | D2IA |
| Beam | | |

The objective of nulling is to improve signal quality by targeting a detrimental Nth order intermodulation beam and degrading the directivity of that beam such that either or both of the degradations (D1IB-D1IA) and (D2IB-D2IA) are large by comparison to corresponding fundamental beam degradations (D1FB-D1FA) and (D2FB-D2FA).

Simulations indicate in a 14×14 array with analog phase shifters PNᵢ₁, PNᵢ₂ the directivity of any odd-order intermodulation beam can be degraded by about 35 dB at a cost of fundamental beam degradation of less than 0.25 dB. Notably, using present day technology, digital phase shifter performance can be expected to fall short of that of analog devices owing to introduction of analog/digital conversion quantization errors.

In some embodiments, a collection of directivity patterns P are stored in a memory device such as a semiconductor or disc drive memory device. The value of P is the directivity of a particular beam. In some embodiments, the memory device 359 is a part of the intermodulation beam nulling computer 361 and in some embodiments the memory device 356 is a part of the beam forming section 350.

Pre-calculation and storage of directivity patterns avoids the need to calculate directivities after angle commands (θ₀, φ₀), (θ′₀, φ′₀) are given. Among other things, pre-calculation and storage saves time and reduces processor requirements. Notably, where commanded angles differ from stored angles, a selection methodology is required such as selection of the closest stored angle data and/or interpolation of the stored angle data to fit the commanded angles.

As persons of ordinary skill in the art will appreciate, stored directivity patterns P can be referenced in different ways. For example, the stored patterns can be stored in a multidimensional matrix such that

P=P(j,k,θ₀ₚ,φ₀ₚ,θ′_{0q},φ′_{0q},θ,φ)

where
1) j is an integer indicating the first fundamental beam (j=1), the second fundamental beam (j=2), the first 3^{rd} order IM beam (j=3), the second 3^{rd} order IM beam (j=4), the first 5^{th} order IM beam (j=4), the second 5^{th} order IM beam (j=5), and so on.
2) k is an integer indicating when nulling is applied (k=1) and when nulling is not applied (k=2).
3) θ₀ₚ, φ₀ₚ indicate the stored elevation and azimuth angles that are closest to the commanded angles for the first signal θ₀, φ₀.
4) θ′₀ₚ, φ_{0q} indicate the stored elevation an azimuth angles that are closest to the commanded angles for the second signal θ′₀, ′φ₀.
5) and, where θ, φ indicate angles relative to the antenna platform's look angle, for example a spacecraft's look angle toward the earth. Here, the antenna pattern P will vary with θ, φ, such that for example, the peak of the first fundamental pattern occurs at angles θ₀ and φ₀.

In some embodiments, adaptation utilizing radiator feedback updates pattern values P to account for radiator element 320 changes such as radiator degradation.

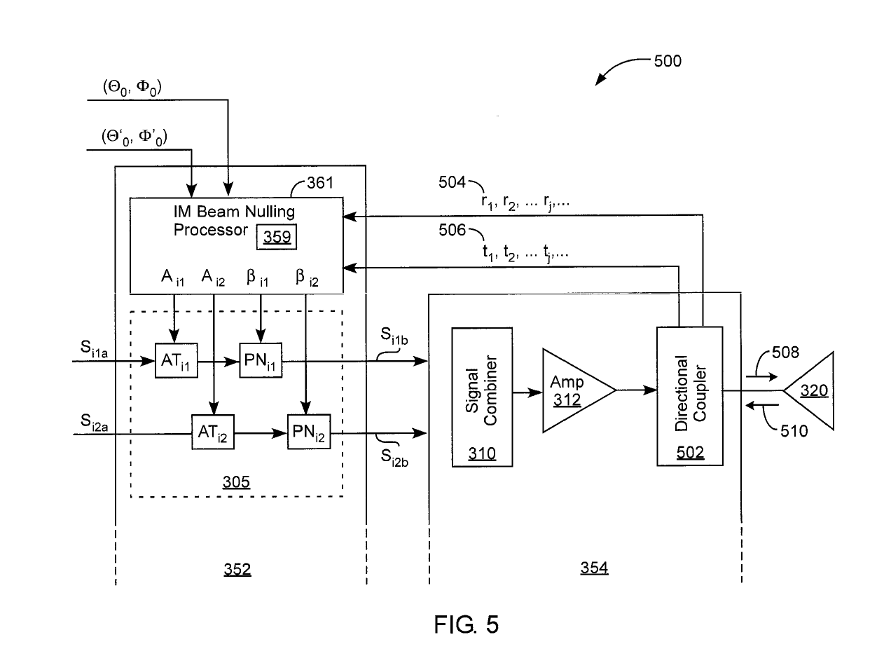

FIG. 5 shows a portion of an active array antenna system including radiator feedback 500. Here, an i^{th} directional coupler 502 is coupled between an i^{th} amplifier 312 and an i^{th} radiator 320. The directional coupler exchanges signals 508, 510 with the radiator 320. The directional coupler samples fundamental and IM forward (t₁, t₂, . . . , tⱼ, . . . ) and reflected (r₁, r₂, . . . , rⱼ, . . . ) traveling wave signal levels at the input of each antenna radiator. These samples are inputs to the IM beam nulling processor 504, 506. Notably, traveling wave signal level changes and in particular increased reflected traveling wave signal levels typically indicate radiator degradation, and, where significant, indicates a need for updating stored pattern values P.

Radiator degradation modifies the radiator's complex excitation coefficient Iₘₙ. As shown above, a radiator's modified excitation coefficient changes values of directivity D that were earlier stored as pattern values P. In essence, actual pattern values change as radiators degrade and stored pattern values are updated to maintain the performance of the nulling system.

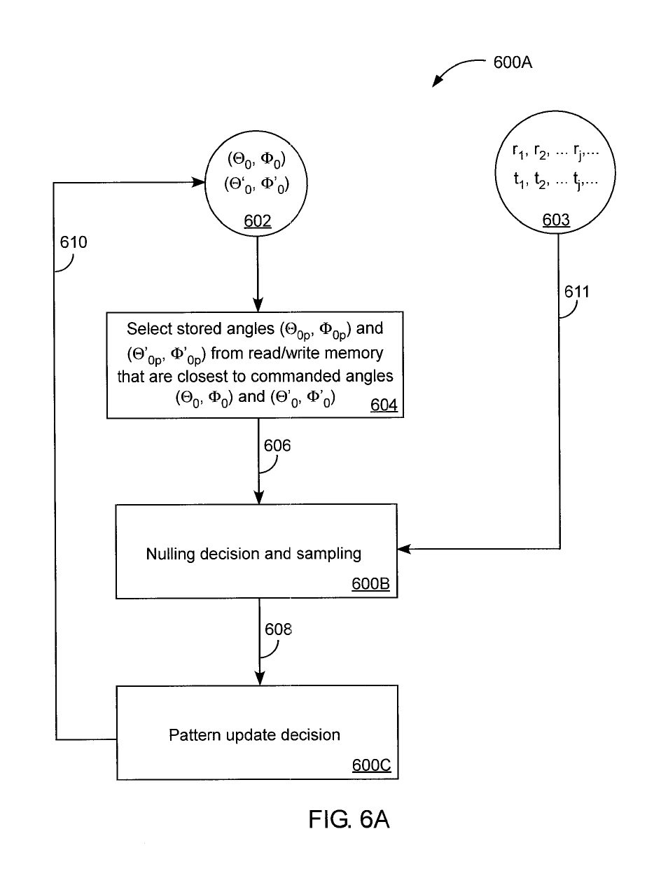

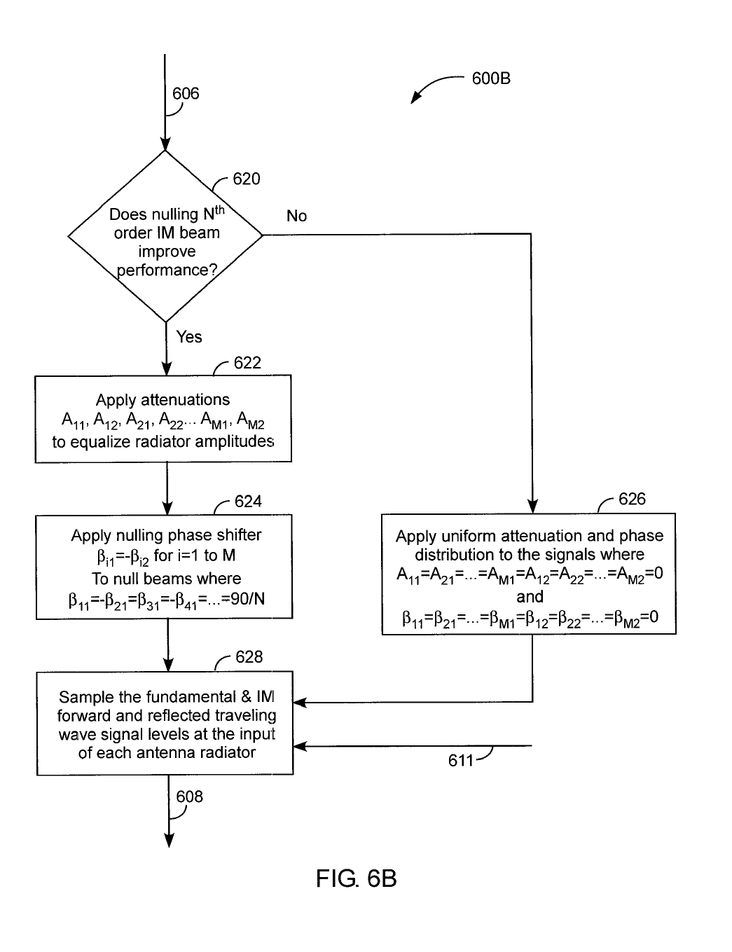

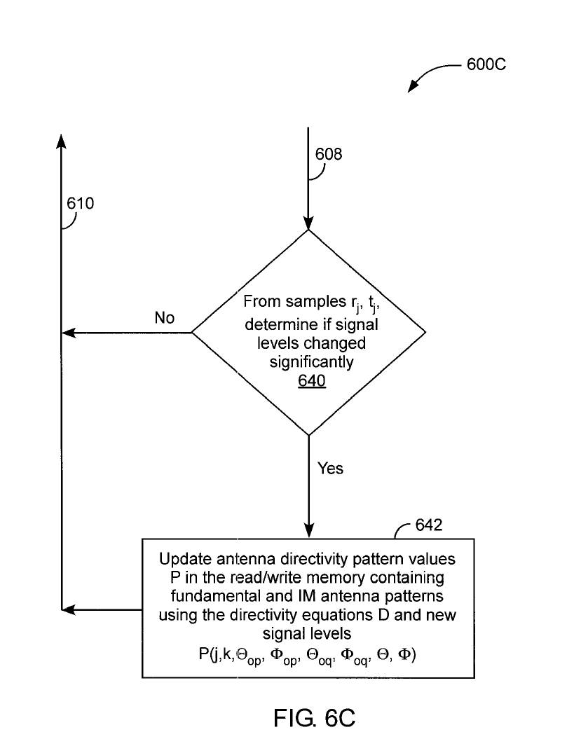

FIGS. 6A-C show flowcharts implementing nulling and pattern value updating 600A-C. In FIG. 6A, commanded angles (θ₀, φ₀), (θ′₀, φ′₀) are inputs 602 to a selection block 604 that matches the commanded angles with the closest (or interpolated) angles (θ₀ₚ, φ₀ₚ), (θ′_{0q}, φ′_{0q}) in a pattern storage device such as the one discussed above 359. A nulling decision and sampling block 600B is coupled 606 to the selection block and is coupled 611 to sample inputs 603 including (r₁, r₂, . . . , rⱼ, . . . ) and (t₁, t₂, . . . , tⱼ, . . . ). A pattern update decision block 600C is coupled 608 to the nulling decision and sampling block. When the pattern decision and update, if any, is completed, another commanded angle input is ready to be accepted 610.

FIG. 6B shows a more detailed flowchart of the nulling decision and sampling function 600B. A decision block 620 is coupled 606 to the selection block 604. If performance is improved by nulling (k=1), then

a) the first attenuation block 622 applies attenuations A₁₁, A₁₂, A₂₁, A₂₂ . . . A_{M1}, A_{M2} to equalize radiator amplitudes and
b) the nulling phase shifter block 624 applies phase shifts such that βᵢ₁=−βᵢ₂ for i=1 to M to null beams where β₁₁=−β₂₁=β₃₁=−β₄₁= . . . =90° /N
Sampling block 628 follows the nulling phase shifter block 624 and samples the forward and reflected traveling wave signal levels at the input of each antenna radiator as discussed above. The sampling block is coupled 608 to the pattern update decision block 600C.

If performance is not improved by applying a checkerboard nulling phase distribution, flow passes from decision block 620 to attenuation block 626 where a uniform attenuation and phase distribution is applied to the signals where A₁₁=A₂₁= . . . =A_{M1}=A₁₂=A₂₂= . . . =A_{M2}=0 and β₁₁=β₂₁= . . . =β_{M1}=β₁₂=β₂₂= . . . =β_{M2}=0.

FIG. 6C shows a more detailed flowchart of the pattern update decision block 600C. The sampling block is coupled 608 to a pattern update decision block 640 that determines whether the fundamental or IM forward and reflected traveling wave signal levels at the input of an antenna radiator have changed significantly. A significant change is one which has been determined a priori to significantly change the directivity.

If there is no significant change, then the process 600A is ready to accept another set of commanded angles 610. If there is a significant change, control passes to the pattern update process 642 which updates the antenna directivity patterns in read/write memory 359 containing fundamental and intermodulation antenna patterns using the directivity equation D and the new signal levels P(j, k, θ₀ₚ, φ₀ₚ, θ′_{0q}, φ′_{0q}, θ, φ).

After pattern updating is completed, the process 600A is ready to accept another set of commanded angles 610.

While various embodiments of the present invention have been described above, it should be understood that they have been presented by way of example only, and not limitation. It will be apparent to those skilled in the art that various changes in the form and details can be made without departing from the spirit and scope of the invention. As such, the breadth and scope of the present invention should not be limited by the above-described exemplary embodiments, but should be defined only in accordance with the following claims and equivalents thereof.

What is claimed is:

1. A phased array antenna system comprising:
a nulling section interposed between a beam forming section and a feed chain section;
an antenna having a plurality of radiators, each radiator coupled to a respective amplifier in the feed chain section;
each amplifier coupled to a respective nulling phase shifter in the nulling section;
each nulling phase shifter coupled to a respective steering phase shifter in the beam forming section;
one or more processors for activating the phase shifters; and,
the phased array antenna system operative to simultaneously transmit a plurality of signals to respective locations.

2. The phased array antenna system of claim 1 further including:
one or more processors for calculating directivity patterns;
one or more memory devices for storing calculated directivity patterns;
a signal sampler for sampling fundamental and intermodulation forward and reflected traveling wave signal levels at the input of each radiator; and,
one or more processors for updating the stored directivity patterns in accordance with the sample values.

3. The phased array antenna system of claim 2 wherein a single processor is used.

4. The phased array system of claim 2 wherein the beam forming section includes a processor and the nulling section includes a processor.

5. A method of nulling an intermodulation beam in a phased array antenna system comprising the steps of:
providing a nulling section interposed between a beam forming section and a feed chain section;
providing an antenna having a plurality of radiators, each radiator coupled to a respective amplifier in the feed chain section;
coupling each amplifier to a respective nulling phase shifter in the nulling section;
coupling each nulling phase shifter to a respective steering phase shifter in the beam forming section;
activating the phase shifters with one or more processors; and,
the phased array antenna system simultaneously transmitting a plurality of signals to respective locations.

6. The method of claim 5, further including the steps of:
calculating directivity patterns with one or more processors;
storing calculated directivity patterns in one or more memory devices;
sampling with a signal sampler fundamental and intermodulation forward and reflected traveling wave signal levels at the input of each radiator; and,
updating the stored directivity patterns in accordance with the sample values with one or more processors.

7. The method of claim 6 further wherein the step of calculating directivity patterns is performed with a single processor.

8. The method of claim 6 further comprising the steps of:
providing the beam forming section with a processor; and,
providing the nulling section with a processor.

9. A method of nulling an intermodulation beam in a phased array antenna system comprising the steps of:
providing a plurality of telecommunications signals together with their commanded angles;
selecting angles from a read/write memory that are closest to the commanded angles;
determining if application of a checkerboard nulling phase distribution to signals derived from the telecommunications signals results in a favorable loss of directionality of a targeted intermodulation beam; and,
where a favorable loss of intermodulation beam directionality is determined, applying the checkerboard nulling phase distribution to signals derived from the telecommunications signal.

10. The method of claim 9 further comprising the steps of:
repeatedly sampling the fundamental and intermodulation forward and reflected traveling wave signal levels at the input of a plurality of antenna radiators;
from samples taken at different times, determining if signal level changes indicate directivity has changed more than a predetermined amount indicating updates are required; and,
where it is determined that updates are required, updating antenna directivity pattern values in the read/write memory containing fundamental and IM antenna patterns.

11. A phased array antenna system comprising:
a combined nulling and beam forming section coupled to a feed chain section;
an antenna having a plurality of radiators, each radiator coupled to a respective amplifier in the feed chain section;
each amplifier coupled to a respective phase shifter in the combined nulling and beam forming section;
a processor operative to combine a steering and a nulling phase shift, the combined phase shift applied to a respective phase shifter; and,
the phased array antenna system operative to simultaneously transmit a plurality of signals to respective locations.
